(19) United States
(12) Patent Application Publication
(10) Pub. No.: US 2022/0178256 A1
(43) Pub. Date: Jun. 9, 2022

(54) ONE CYLINDER AXIAL INTERNAL COMBUSTION ENGINE HAVING SCOTCH-YOKE BASED TWO PHASE FUEL COMPRESSION SYSTEM

(71) Applicant: Ravi Shankar Gautam, Gaya (IN)

(72) Inventor: Ravi Shankar Gautam, Gaya (IN)

(21) Appl. No.: 17/442,713

(22) PCT Filed: May 26, 2020
(86) PCT No.: PCT/IN2020/050467

§ 371 Date: Sep. 24, 2021

(30) Foreign Application Priority Data
May 24, 2019 (IN) 201921020756

(51) Int. Cl. F01B 9/02; F16H 21/36; F02B 75/32; F02B 75/16

(52) U.S. Cl. CPC F01B 9/023; F02B 75/16; F02B 75/32; F16H 21/36

(57) ABSTRACT

This patent discloses one cylinder axial internal combustion engine having Scotch-Yoke based two phase fuel compression system. Scotch-Yoke actuator employed here is a specially modeled Multi Purpose Multi H-Slot double action Scotch-Yoke Actuator. Each H-slot is quad-laterally operated by a special mechanism. It performs suction and compression in ignition chamber and auxiliary compression chamber via two piston plates one in each chamber and transfers compressed fuel-air mixture from auxiliary compression chamber to ignition chamber through yoke rod. Flywheel is coaxially mounted on the outward side of the auxiliary compression chamber.

### FIELD OF INVENTION

The present disclosure relates generally to axial piston engine which can use petrol, diesel, compressed natural gas etc as fuel.

### BACKGROUND OF INVENTION

Axial piston engines have various applications in industries. Duke engine is one of the most coveted axial piston engines.

Engine like Bourke's engine that use Scotch Yoke actuator for suction and compression are not axial engine.

### Technical Problem

One of the drawbacks of Duke engine is that it needs multiple cylinders, at least five to six cylinders, and parts like swash plate etc which can convert rotatory motion along transverse axis to rotatory motion along axis of circular ensemble of combustion chambers. Cam groove of Swash plate may incur lot of wear due to friction.

Scotch-Yoke actuator currently employed in engines like Bourke engine have single yoke slot and suffers from problem of sideward thrust many other problems. Further scotch yoke actuator with its operation mechanism makes it unsuitable to be used for axial engines. Problem of sideward thrust have been addressed in the patent U.S. Pat. No. 4,075,898. We have addressed the problem in a different way.

One of the drawbacks of one slot scotch yoke is the friction caused by yoke pin in bounding plates of yoke slot. This issue of friction has been addressed by many inventors including the patent U.S. Pat. No. 4,559,838.

One of the drawbacks of one slot scotch yoke is that it may not be suitable for high torque application. This is insufficient use of the scotch yoke mechanism.

### SUMMARY OF INVENTION

In order to address the drawback mention in paragraph [04], we use scotch yoke actuator operated in special way.

Engine, according to this invention, uses cam operated specially designed multi-purpose quad-laterally operated double action scotch-yoke mechanism which facilitates two phase suction and compression of fuel. It reduces the sustained open state of inlet valves. Fuel supply is distributed to two inlet valves with one of them separate from ignition chamber.

In the engine, according to this invention, specially designed double action scotch yoke actuator is used to two phase compression which helps to achieve high compression ratio.

In order to facilitate two phase compression, yoke of the Scotch-Yoke actuator is a continuous rod having a longitudinal hole through its length is utilized to transfer the compressed gas from the auxiliary compression chamber to the combustion chamber. In the combustion chamber the fuel-air mixture sucked from the poppet valve and compressed air-fuel mixture received from compressed chamber is further compressed. High compression ratio increases fuel efficiency. Two phase compression system facilitates high compression ratio without increase in size of the combustion chamber and traversal distance of the Scotch-Yoke actuator.

Engine employing two phase compression mechanism has two constraints. First constraint is that auxiliary compression chamber needs to be of length equal to that of combustion chamber (located at rearward end of the engine). Length of auxiliary compression chamber for given volume V and radius r is V/(pi*r³). Second constraint is that rotation space of crank needs to lie beyond the auxiliary compression chamber. Flywheel gear that is mounted on the outward side of auxiliary compression chamber which needs to be crown gear needs to have rearward extended teeth so that the flywheel gear can mesh with cam follower gear operating the crank. Otherwise we will need to have cam follower gear of larger radius in order to be able to mesh with cam gear which in turn would require cam gear to be larger radius (as radius of cam gear needs to be double of that of cam follower gear). Thus we do not gain any efficiency more rotatory force will be spent to rotate the cam gear and cam follower gear. Also this arrangement will forbid the possibility of allowing multiple slots for the scotch yoke mechanism as the cam follower gear for the subsequent slots need to have same radius (and therefore large radius). In order these issues, we use quad-lateral transmission mechanism for transmission of rotation between flywheel gear and cam follower gear.

In one embodiment we introduce quad-laterally operated H-slot (quad-partitioned slot) in scotch yoke mechanism in order to overcome drawbacks mentioned in paragraphs [5] to [8].

Inclusion of multiple slots and its operation with the help of special type of Scotch-Yoke operation mechanism makes Scotch-Yoke actuator appropriate for high torque application.

Multiple yoke slots facilitate the application of force on larger area and therefore less friction on the bounding plates of the yoke slot and lesser torsional force on the yoke slot. Multiple slots functions as reinforcement mechanism to support high torque application, to reduce sideward thrust. incurring less wear and tear resulting in improved life time of the Scotch-Yoke actuator.

Yoke slots of the multi-slot scotch yoke are stacked in parallel along yoke slot with bounding plate of one slot facing the bounding plate of subsequent slot. In the resulting quad-laterally driven multi slot scotch yoke mechanism we have, retained bidirectional movement of pins on opposite sides. That is, pins on the subslots on opposite sides of a yoke slot are on the opposite sides at equal distance midpoint of the yoke slot.

In the second embodiment, a transmission gear is mounted between the cam gear and first set of cam follower gear and each set of cam follower gear is meshingly engaged with subsequent set cam follower gear.

Additionally, quad-lateral crank operation mechanism facilitates more teeth contact with flywheel gear mounted on auxiliary compression chamber.

Scotch yoke actuator, and its operation mechanism in this invention are of four different models with each model having additional advantage apart from the advantage described above.

### BRIEF DESCRIPTION OF DRAWINGS

FIG. 1 to FIG. 8 One cylinder axial engine using quad-laterally operated multi slot scotch yoke actuator according to the first model in this invention.

FIG. 1 One cylinder axial engine showing Multi-Slot Scotch Yoke Operation Mechanism (MSYM) according to the first model in this invention.

FIG. 2 and FIG. 3 Split view of one cylinder axial engine according to the first model with auxiliary compression chamber split.

FIG. 4 and FIG. 5 Front and rear view, respectively, of quad-laterally operated Multi-Slot-Scotch-Yoke actuator (MSYA), according to the first model in this invention.

FIG. 6 First yoke H-slot (FYS) and second yoke H-slot (SYS), common to all four models of quad-laterally operated Multi-Slot-Scotch-Yoke actuator (MSYA), according to this invention.

FIG. 7 Arrangement of crank gear and its pin of quad-laterally operated Multi-Slot-Scotch-Yoke actuator (MSYA), according to the first model in this invention.

FIG. 8 Intermediate yoke rod support (IYRS) and Inter-Slot Reinforcement Mechanism (ISRM) for additional support mechanism for multiple slots.

FIG. 9 to FIG. 12 One cylinder axial engine using quad-laterally operated multi slot scotch yoke actuator according to the second model in this invention.

FIG. 9 Rear part of One cylinder axial engine showing Multi-Slot Scotch Yoke Operation Mechanism (MSYM) according to the second model in this invention.

FIG. 10 Front view of quad-laterally operated Multi-Slot-Scotch-Yoke actuator (MSYA), according to the second model in this invention.

FIG. 11 Rear view of quad-laterally operated Multi-Slot-Scotch-Yoke actuator (MSYA), according to the second model in this invention.

FIG. 12 Arrangement of crank gear and its pin of quad-laterally operated Multi-Slot-Scotch-Yoke actuator (MSYA), according to the second model in this invention.

FIG. 13 to FIG. 16 One cylinder axial engine using quad-laterally operated multi slot scotch yoke actuator according to the third model in this invention.

FIG. 13 Rear part of Thrust vectoring ignition chamber engine showing Multi-Slot Scotch Yoke Operation Mechanism (MSYM) according to the third model in this invention.

FIG. 14 Front view of quad-laterally operated Multi-Slot-Scotch-Yoke actuator (MSYA), according to the third model in this invention.

FIG. 15 Rear view of quad-laterally operated Multi-Slot-Scotch-Yoke actuator (MSYA), according to the third model in this invention.

FIG. 16 Arrangement of crank gear and its pin of quad-laterally operated Multi-Slot-Scotch-Yoke actuator (MSYA), according to the third model in this invention.

FIG. 17 to FIG. 20 One cylinder axial engine using quad-laterally operated multi slot scotch yoke actuator according to the fourth model in this invention.

FIG. 17 Rear part of one cylinder axial engine showing Multi-Slot Scotch Yoke Operation Mechanism (MSYM) according to the fourth model in this invention.

FIG. 18 Front view of quad-laterally operated Multi-Slot-Scotch-Yoke actuator (MSYA), according to the fourth model in this invention.

FIG. 19 Rear view of quad-laterally operated Multi-Slot-Scotch-Yoke actuator (MSYA), according to the fourth model in this invention.

FIG. 20 Arrangement of crank gear and its pin of quad-laterally operated Multi-Slot-Scotch-Yoke actuator (MSYA), according to the fourth model in this invention.

FIG. 21 Schematic diagrams of left side view of operation between crank gears of Multi-Slot-Scotch-Yoke actuator (MSYA) and flywheel gear (FWG) and cam follower gears of Multi-Slot-Scotch-Yoke operation mechanism (MSYM) according to first model in this invention. Solid dot represent pin of the corresponding crank gear.

FIG. 22 Schematic diagrams of right side view of operation between crank gears of Multi-Slot-Scotch-Yoke actuator (MSYA) and flywheel gear (FWG) and cam follower gears of Multi-Slot-Scotch-Yoke operation mechanism (MSYM) according to first model in this invention. Solid dot represent pin of the corresponding crank gear.

FIG. 23 Schematic diagrams of left side view of operation between crank gears of Multi-Slot-Scotch-Yoke actuator (MSYA) and flywheel gear (FWG) and cam follower gears of Multi-Slot-Scotch-Yoke operation mechanism (MSYM) according to second model in this invention.

FIG. 24 Schematic diagrams of right side view of operation between crank gears of Multi-Slot-Scotch-Yoke actuator (MSYA) and flywheel gear (FWG) and cam follower gears of Multi-Slot-Scotch-Yoke operation mechanism (MSYM) according to second model in this invention.

FIG. 25 Schematic diagrams of operation between first quad-lateral crank operation mechanism (FQCM) and second quad-lateral crank operation mechanism (SQCM) (causing operation between first quad-lateral crank-pin set (FQCP) and second quad-lateral crank-pin set (SQCP), of Multi-Slot-Scotch-Yoke actuator (MSYA)) of Multi-Slot-Scotch-Yoke operation mechanism (MSYM) according to third model in this invention.

FIG. 26 Schematic diagrams of operation between first quad-lateral crank operation mechanism (FQCM) and second quad-lateral crank operation mechanism (SQCM) (causing operation between first quad-lateral crank-pin set (FQCP) and second quad-lateral crank-pin set (SQCP), of Multi-Slot-Scotch-Yoke actuator (MSYA)) of Multi-Slot-Scotch-Yoke operation mechanism (MSYM) according to fourth model in this invention.

### DESCRIPTION OF EMBODIMENTS

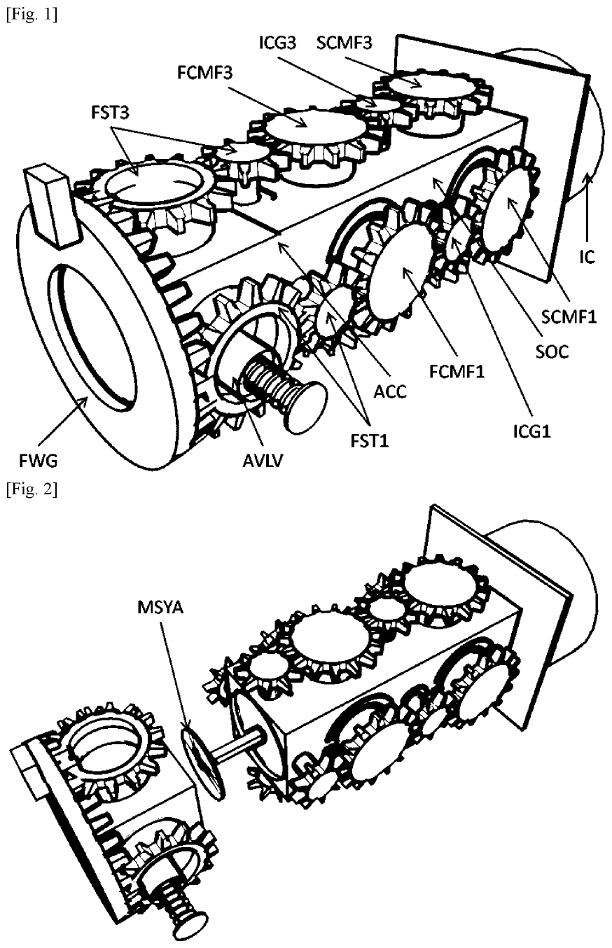

Referring to FIG. 1, the preferred embodiment of an axial engine, according to this invention, is shown to include an ignition chamber (IC), fuel suction and compression system (FSCS) and flywheel gear (FWG).

Ignition chamber (IC), as shown in FIG. 3, located on rear side of the engine, is an horizontal annular cylinder, extending from rear to front, capped at its rear side and have spark plug, primary fuel inlet valve and exhaust valve mounted on its rear cap with primary fuel inlet valve (PVLV) and exhaust valve (EVLV) being poppet valves and primary fuel inlet valve (PVLV) being connected to air-fuel mixture source.

Fuel suction and compression system (FSCS), as shown in FIG. 2 and FIG. 3, which is designed for two phase suction-compression followed by combustion of air-fuel mixture in the ignition chamber, consists of Scotch-Yoke operation chamber (SOC), auxiliary compression chamber (ACC), fuel delivery mechanism (FDM) wherein
Scotch-Yoke operation chamber (SOC), as shown in FIG. 1 to FIG. 3, a horizontal rectangular pipe with circular hole in rear and front side, is located between ignition chamber (IC) and auxiliary compression chamber (ACC);
auxiliary compression chamber (ACC), as shown in FIG. 2 and FIG. 3, being an horizontal enclosure with rectangular cross-section and longitudinally coaxial cylindrical cavity of inner radius greater than and length equal to that of ignition chamber, with a front end cap, is sealingly attached at its rear end to the front end of Scotch-Yoke operation chamber (SOC);
fuel delivery mechanism (FDM), as shown in FIG. 1 to FIG. 3, consists of an auxiliary valve (AVLV), a Multi-Slot-Scotch-Yoke actuator (MSYA) and Multi-Slot-Scotch-Yoke operation mechanism (MSYM);
auxiliary valve (AVLV), as shown in FIG. 1, is a poppet valve operated by a solenoid coil and is housed in the cylindrical deck on rear end of left wall of auxiliary compression chamber (ACC) inside the region bounded by front end annular spur gear of left Flywheel-Scotch transmission mechanism (FST1) and is connected to a air-fuel mixture source.

Fuel delivery mechanism (FDM) which performs suction of air-fuel mixture into ignition chamber (IC) and auxiliary compression chamber (ACC), compression of the mixture in both chambers and transferring compressed mixture from auxiliary compression chamber (ACC) to ignition chamber (IC) has four models, namely first model, second model, third model and fourth model, with each model differing from the other in comprising different model of Multi-Slot-Scotch-Yoke actuator (MSYA) and corresponding Multi-Slot-Scotch-Yoke operation mechanism (MSYM) wherein different model differ in the way
crank crank pins corresponding to a yoke slot are oriented with respect to each other and accordingly crank gears for the slot mesh or not mesh with adjacent crank gears;
crank gear corresponding to a yoke slot transmit rotatory force to crank gear corresponding to adjacent yoke slot by directly meshing or via an idler gear;
scotch yoke operation mechanism is configured corresponding to the configuration of crank-pin gear set.

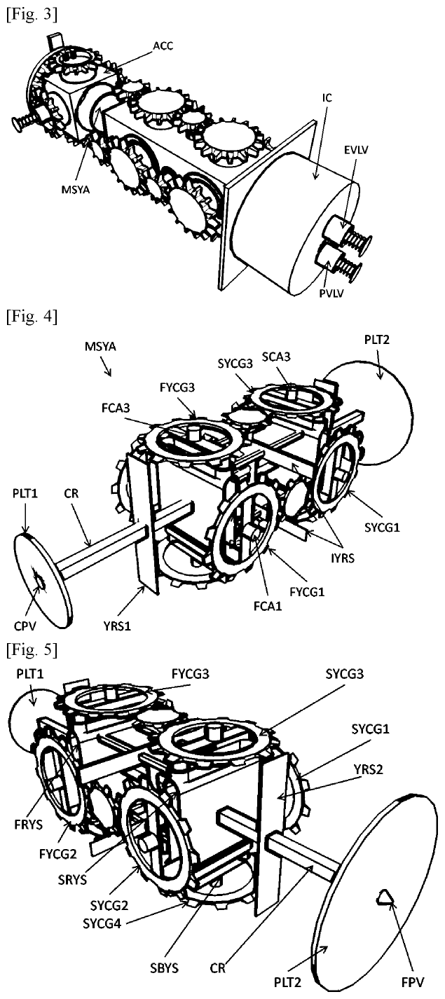

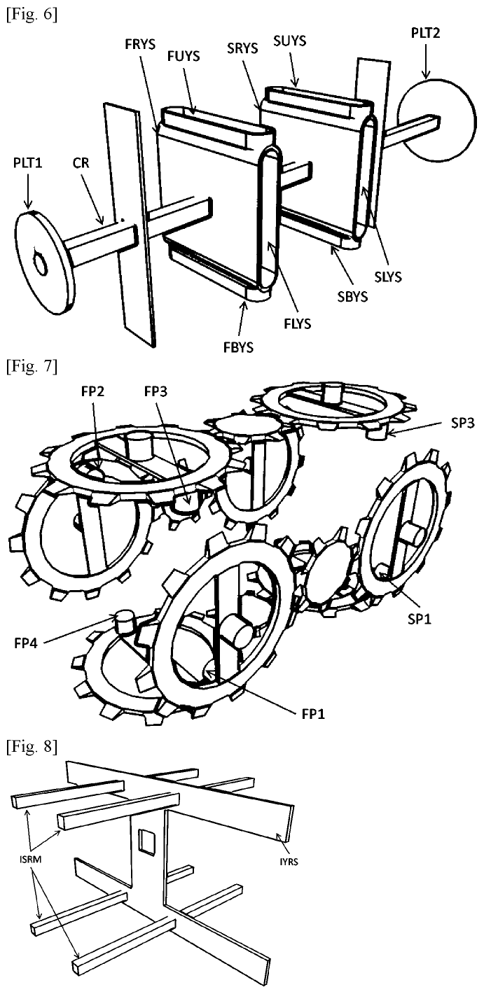

According to the first model, Multi-Slot-Scotch-Yoke actuator (MSYA), a multi-purpose quad-laterally operated double action multi slot scotch-yoke mechanism, is shown in FIG. 4, FIG. 5, FIG. 6, FIG. 7, and FIG. 8, to consist of two yoke slots, namely first yoke slot (FYS), second yoke slot (SYS), a connecting rod (CR), two quad-lateral crank-pin set, namely first quad-lateral crank-pin set (FQCP), second quad-lateral crank-pin set (SQCP), front yoke rod support (YRS1), and rear yoke rod support (YRS2), intermediate yoke rod support (IYRS), Inter-Slot Reinforcement Mechanism (ISRM), front piston plate (PLT1), rear piston plate (PLT2), fuel pressure valve (FPV) and compressor pressure valve (CPV) wherein
each of first yoke slot (FYS), and second yoke slot (SYS), is a yoke slot with front end dwell located such that slot opens towards left crank wheel, right crank wheel, upper crank wheel, and bottom crank wheel;
first yoke slot (FYS), and second yoke slot (SYS), are consecutively arranged that is, rear bounding plate of first yoke slot (FYS), parallely faces the front bounding plate of second yoke slot (SYS),
first yoke slot (FYS) has four sub-slots, two of which, namely first left yoke slot (FLYS), first right yoke slot (FRYS) are obtained by vertically partitioning a vertical slot along the mid part, and other two , namely, first upper yoke slot (FUYS), first bottom yoke slot (FBYS) are obtained by adjoining horizontally oriented slots on the upper and lower sides of the vertical slot;
second yoke slot (SYS) has four sub-slots, two of which, namely second left yoke slot (SLYS), second right yoke slot (SRYS) are obtained by vertically partitioned along the mid part, and other two, namely, second upper yoke slot (SUYS), second bottom yoke slot (SBYS) are obtained by adjoining horizontally oriented slots on the upper and lower sides of the vertical slots;
connecting rod, (CR), which functions as continuous yoke slot, is a horizontal rod, with a longitudinal coaxial cylindrical hole, passing through all the slots, first yoke slot (FYS), second yoke slot (SYS), and attached to them;
front piston plate (PLT1) and rear piston plate (PLT2), circular disks with holes at their centers, are attached coaxially to the front and rear end, respectively, of connecting rod;
front piston plate (PLT1) of radius equal to inner radius of air compression chamber (ACC) and is housed coaxially inside the latter;
rear piston plate (PLT2) of radius equal to inner radius of ignition chamber (IC) and is housed coaxially inside the latter;
fuel pressure valve (FPV) and compressor pressure valve (CPV) are pressure valves, opening rearward (towards the ignition chamber), mounted coaxially to the centers of front piston plate (PLT1) and rear piston plate (PLT2) respectively, so that fuel, in the auxiliary compression chamber (ACC), under pressure can enter through compressor pressure valve (CPV) pass through cylindrical hole in the connecting rod (CR) and exit from the fuel pressure valve (FPV) into the ignition chamber;
first quad-lateral crank-pin set (FQCP), which quad-laterally operates first yoke slot, comprises first left yoke crank gear (FYCG1), first right yoke crank gear (FYCG2), first upper yoke crank gear (FYCG3) and first bottom yoke crank gear (FYCG4), first left inner bearing (FB5), first right inner bearing (FB6), first upper inner bearing (FB7), first bottom inner bearing (FB8), first left yoke pin (FP1), first right yoke pin (FP2), first upper yoke pin (FP3), and first bottom yoke pin (FP4);
second quad-lateral crank-pin set (SQCP), which quad-laterally operates second yoke slot, comprises second left yoke crank gear (SYCG1), second right yoke crank gear (SYCG2), second upper yoke crank gear (SYCG3) and second bottom yoke crank gear (SYCG4), second left inner bearing (SB5), second right inner bearing (SB6), second upper inner bearing (SB7), second bottom inner bearing (SB8), second left yoke pin (SP1), second right yoke pin (SP2), second upper yoke pin (SP3), and second bottom yoke pin (SP4);
each crank gear of a quad-lateral crank-pin set is a spur gear journalled on corresponding side (left, right, upper or bottom) of inner wall of Scotch-Yoke operation chamber (SOC) facing a yoke slot with its center along the midpoint of corresponding yoke slot via an inner ball bearing (which are annular thrust ball bearings) and engaged with corresponding sub-slot of corresponding yoke slot via corresponding yoke pin;
each pin of a quad-lateral crank-pin set, is a cylindrical peg projecting outwards from the periphery of a crank gear to engage with corresponding yoke sub slots (for example, first left yoke pin (P1) projects outward from the periphery of first left yoke crank gear (FYCG1) to engage with first left yoke slot (FLYS));
crank gears corresponding to a yoke slot are assembled such that the corresponding left yoke pin and right yoke pin are on the opposite sides on the midpoint of the corresponding yoke slot with equal distance from the said midpoint and corresponding upper yoke pin and bottom yoke pin are on the opposite sides on the midpoint of the corresponding yoke slot with equal distance from the said midpoint;
left crank gear and right crank gear do not mesh with upper and bottom crank gear;
inter-slot transmission mechanism (ISTM), consists of four spur gears, namely left inter-slot gear (ISG1), right inter-slot gear (ISG2), upper inter-slot gear (ISG3) and bottom inter-slot gear (ISG4), journalled on the inner side of left, right, upper and bottom wall, respectively, of scotch-yoke operation chamber (SOC), between the corresponding first and second crank gears and function as idler gear;
front yoke rod support, (YRS1) and rear yoke rod support (YRS2) are vertical rods, located inside Scotch-Yoke operation chamber (SOC), on front side of traversal space of front yoke slot and rear side of traversal space of rear yoke slot, respectively;
each intermediate yoke rod support (IYRS), as shown in FIG. 4 and FIG. 8, is a horizontally oriented H-shaped truss of appropriated thickness, located inside Scotch-Yoke operation chamber (SOC), empty space between the traversal space of consecutive yoke slots;
Inter-Slot Reinforcement Mechanism (ISRM), as shown in FIG. 4 and FIG. 8, consists of four straight horizontal rods each of which connects oppositely facing bounding plates consecutive yoke slots near one of the four corners of said plates and passes through holes in horizontal arms of intermediate yoke rod support (IYRS);
all yoke rod supports, has a hole through which connecting rod (CR) (that is, continuous yoke) passes through.

According to the first model, Multi-Slot-Scotch-Yoke operation mechanism (MSYM), as shown in FIG. 1, FIG. 2, and FIG. 3, consists of a Flywheel gear (FWG) with a counter weight, Flywheel-Scotch transmission mechanism (FST), two quad-lateral crank operation mechanism, namely, first quad-lateral crank operation mechanism (FQCM) and second quad-lateral crank operation mechanism (SQCM), inter-cam transmission mechanism (ICTM), wherein
Flywheel gear (FWG), that functions as output of the engine, is a circular annular crown gear with its tooth projecting rearward (that is, towards Scotch-Yoke operation chamber) with weight connected to a section (functioning as counter weight) and is coaxially mounted on the outward side (capped front side) of auxiliary compression chamber (ACC);
first quad-lateral crank operation mechanism (FQCM) operates first quad-lateral crank-pin set (FQCP) and comprises first left cam follower gear (FCMF1), first right cam follower gear (FCMF2), first upper cam follower gear (FCMF3) and first bottom cam follower gear (FCMF4), first left cam axis (FCA1), first right cam axis (FCA2), first upper cam axis (FCA3), first bottom cam axis (FCA4), four ball bearings, namely, first left outer bearing (FB1), first right outer bearing (FB2), first upper outer bearing (FB3), first bottom outer bearing (FB4);
second quad-lateral crank operation mechanism (SQCM) operates second quad-lateral crank-pin set (SQCP) and comprises second left cam follower gear (SCMF1), second right cam follower gear (SCMF2), second upper cam follower gear (SCMF3), second bottom cam follower gear (SCMF4), second left cam axis (SCA1), second right cam axis (SCA2), second upper cam axis (SCA3), second bottom cam axis (SCA4), four ball bearings, namely, second left outer bearing (SB1), second right outer bearing (SB2), second upper outer bearing (SB3), second bottom outer bearing (SB4);
left cam follower gear, right cam follower gear, upper cam follower gear and bottom cam follower gear are spur gears coaxial to crank gears corresponding to yoke slot, with radius equal to half the radius of Flywheel gear (FWG), coaxially journalled on outer side the left, right, upper and bottom wall, respectively, of Scotch-Yoke operation chamber (SOC) via corresponding ball bearings, that is, left outer bearing, right outer bearing, upper outer bearing and bottom outer bearing, respectively;

left cam axis, right cam axis, upper cam axis and bottom cam axis are straight rods attached at one end to the center of left cam follower gear, right cam follower gear, upper cam follower gear and bottom cam follower gear respectively and extends inside the Scotch-Yoke Operation Chamber (SOC) from latter's left, right, upper and bottom wall, respectively, to connect to the center of corresponding crank gear;
Flywheel-Scotch transmission mechanism (FST) facilitates transmission of rotatory from cam follower gears of first quad-lateral crank operation mechanism (FQCM) to flywheel gear (FWG) and vice-versa and consists of four sub-mechanisms, namely, left Flywheel-Scotch transmission mechanism (FST1), right Flywheel-Scotch transmission mechanism (FST2), upper Flywheel-Scotch transmission mechanism (FST3), bottom Flywheel-Scotch transmission mechanism (FST4);
each of left Flywheel-Scotch transmission mechanism (FST1), right Flywheel-Scotch transmission mechanism (FST2), upper Flywheel-Scotch transmission mechanism (FST3) and bottom Flywheel-Scotch transmission mechanism (FST4), are gear trains of two (or more according to length of Auxiliary Compression Chamber (ACC)) with each gear train being of equal length, mating spur gears, arranged from rear to front, with one gear on the front end necessarily being annular spur gear (in order to accommodate auxiliary fuel valve (AVLV)), journalled to the outer side of left, right, upper and bottom wall, respectively, of Auxiliary Compression Chamber (ACC) and front spur gear meshingly engages (towards the front end of Auxiliary Compression Chamber (ACC)) with flywheel gear (FWG), (functioning as its pinion gear) and meshingly engages (towards the rear end of Auxiliary Compression Chamber (ACC)) with the first left cam follower gear (FCMF1), first right cam follower gear (FCMF2), first upper cam follower gear (FCMF3) and first bottom cam follower gear (FCMF4), respectively;
each of left Flywheel-Scotch transmission mechanism (FST1), right Flywheel-Scotch transmission mechanism (FST2), upper Flywheel-Scotch transmission mechanism (FST3) and bottom Flywheel-Scotch transmission mechanism (FST4), are gear trains of same number of gears and equal lengths;
inter-cam transmission mechanism (ICTM), consists of four spur gears, namely left inter-cam gear (ICG1), right inter-cam gear (ICG2), upper inter-cam gear (ICG3) and bottom inter-cam gear (ICG4), journalled on the outer side of left, right, upper and bottom wall, respectively, of scotch-yoke operation chamber (SOC), between the corresponding first and second cam follower gears and function as idler gear.

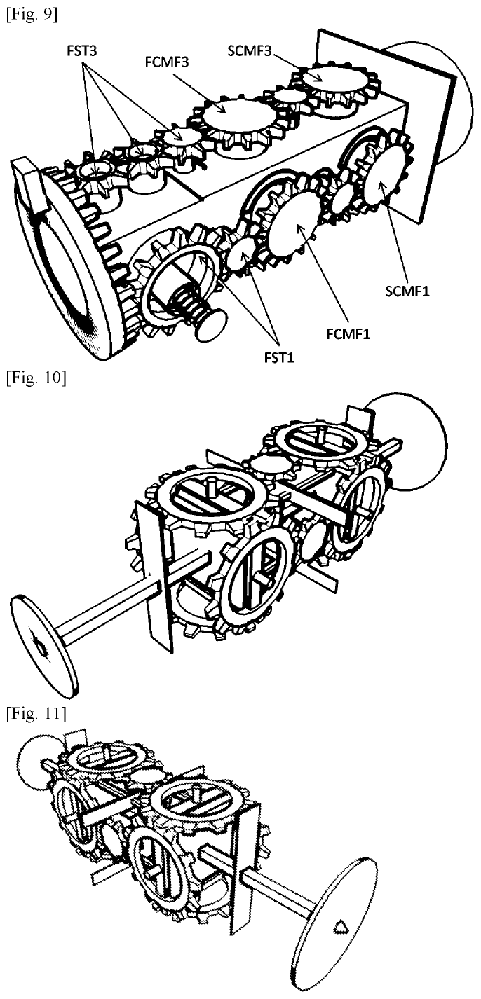

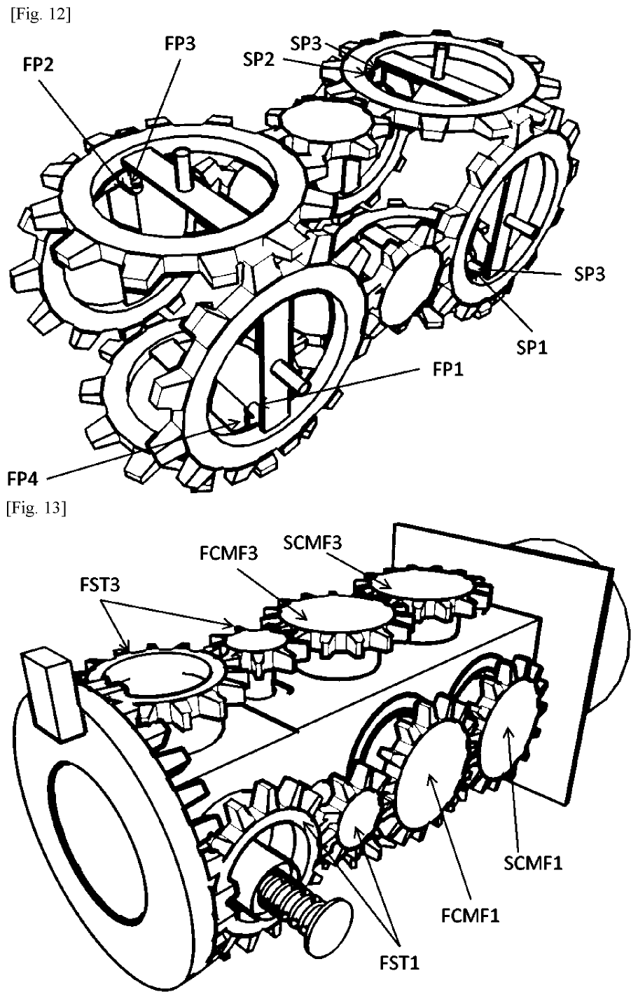

Second model of Multi-Slot-Scotch-Yoke actuator (MSYA) and corresponding Multi-Slot-Scotch-Yoke operation mechanism (MSYM), as shown in FIG. 9, FIG. 10, FIG. 11, and FIG. 12, is a variation of the first model with the variation being
left and right crank gears of each crank-pin set are meshingly engaged with upper and bottom crank gears;
Flywheel-Scotch transmission mechanism (FST) is modified to rotate the first left, right, upper and bottom cam follower gears in consonance with two modification being
   a) upper Flywheel-Scotch transmission mechanism (FST3), and bottom Flywheel-Scotch transmission mechanism (FST4), are gear trains of same number of gears but one gear more than that of left Flywheel-Scotch transmission mechanism (FST1), (or right Ignition-to-Scotch transmission gear (FST2));
   b) radii of spur gears of upper Flywheel-Scotch transmission mechanism (FST3), bottom Flywheel-Scotch transmission mechanism (FST4) are appropriately smaller than that of left Ignition-to-Scotch transmission gear (FST1), and right Flywheel-Scotch transmission mechanism (FST2), such that all the gear trains of Flywheel-Scotch transmission mechanism (FST) are of equal lengths.

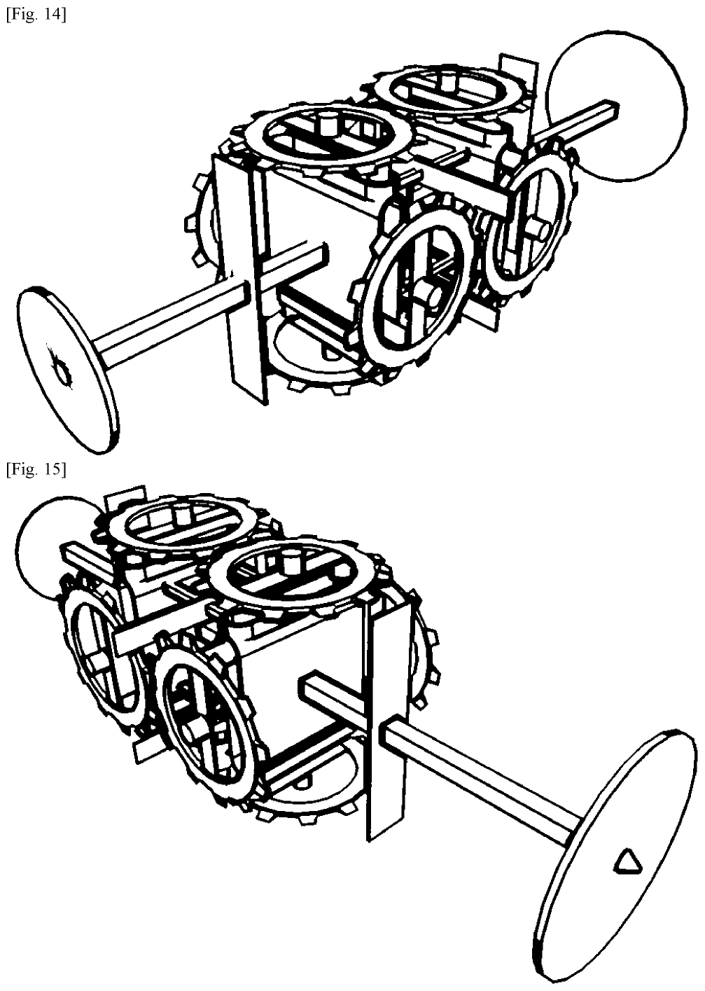

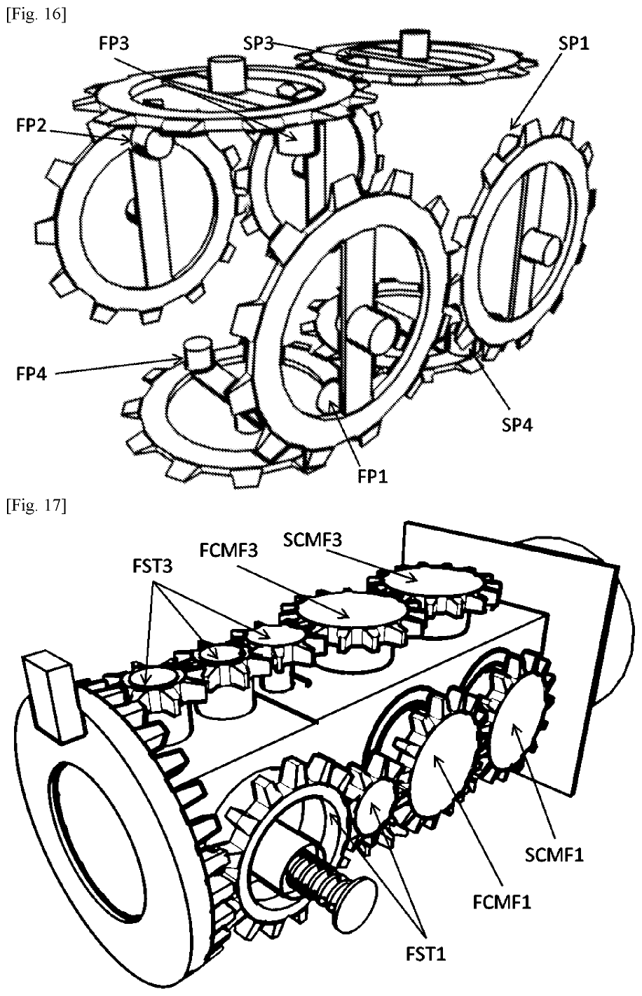

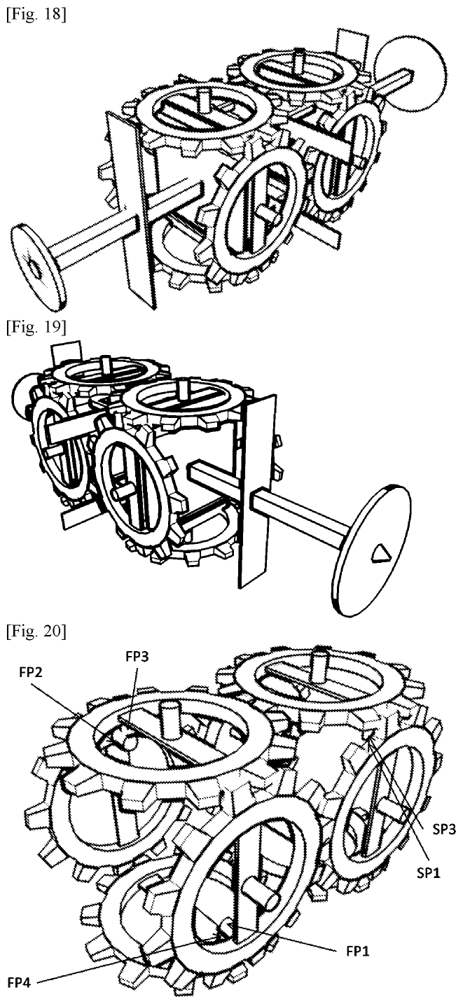

Third model, as shown in FIG. 13, FIG. 14, FIG. 15 and FIG. 16, and fourth model, as shown in FIG. 17, FIG. 18, FIG. 19 and FIG. 20, of Multi-Slot-Scotch-Yoke actuator (MSYA), and corresponding Multi-Slot-Scotch-Yoke operation mechanism (MSYM), are variations of first and second model, respectively, with the variation being
inter-slot transmission mechanism (ISTM) is removed (that is, interslot gears are removed) and consecutive crank gears on each side are meshingly engaged and pins of consecutive crank gears are oppositely oriented with respect to each other;
inter-cam transmission mechanism (ICTM), is removed and consecutive cam follower gears on each side are meshingly engaged with each other.

In second and fourth model, upper and bottom crank gears may be crown gear with teeth extending in the vertical direction according to the depth of upper and bottom yoke sub-slots. The said crank gear teeth appropriately extend sideways to meshingly engage with neighboring gears.

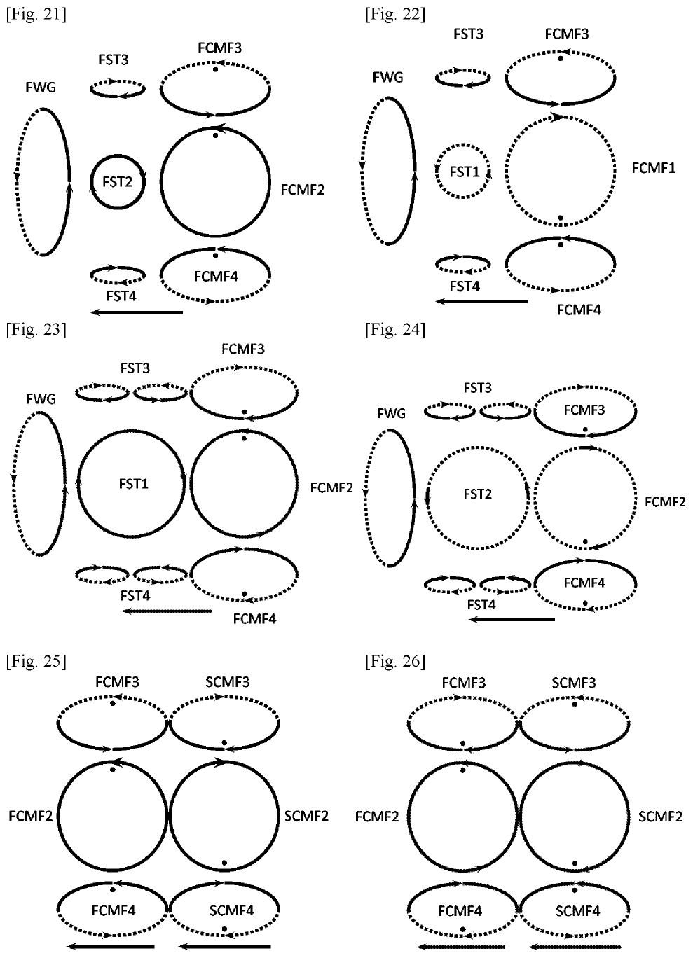

Schematic diagrams in FIG. 21 to FIG. 26 illustrates operation of between crank gears of Multi-Slot-Scotch-Yoke actuator (MSYA) and flywheel gear (FWG) and Multi-Slot-Scotch-Yoke operation mechanism (MSYM) according to first model, second model, third model and fourth model in this invention. Ellipses and circles represent the cam follower gears (and crank gears), Flywheel-Scotch transmission (FST) gears and Flywheel gear (FWG) with ellipses represent the gears mounted on upper and bottom side of scotch-yoke-operation chamber (SOC) and circles represent gears mounted on left and right side of scotch-yoke-operation chamber (SOC). Solid portions represent the side facing the reader and dotted portions represent the side away from the reader. Each of the big dots represents pin of corresponding crank gear being operated. Arrow on the circles and ellipses represent the direction of rotation of gears. All the schematic diagrams describe the operation of scotch yoke actuator for movement of scotch yoke towards the flywheel gear represented by straight arrow.

Four Stroke Cycle of the Engine

During combustion phase in ignition chamber, compressed air-fuel mixture is ignited by spark plug and explosion of air-fuel mixture pushes rear piston plate housed in ignition chamber (IC) towards front direction causing yoke slots to move towards front direction which in turn cause rotation of all crank gears of both the quad-lateral crank-pin set which in turn cause cam follower gears of quad-lateral crank-operation mechanism to rotate. Rotation of cam follower gears of first quad-lateral crank-operation mechanism is transmitted to Flywheel gear by Flywheel-Scotch transmission mechanism. As the counter weight attached to Flywheel gear comes to the upper side it forces the Flywheel gear to continue to rotate to complete at least a semicircle with considerable momentum and the rotation of Flywheel gear is transmitted to cam follower gears of first quad-lateral crank-operation mechanism by Flywheel-Scotch transmission mechanism which ultimately causes rear piston plate to move rearward direction and expel out burnt gas through exhaust valve. At the same time front piston plate while moving rearward direction sucks air-fuel mixture from auxiliary valve into compression chamber. While the Flywheel gear continues to rotate another semicircle (due to momentum created in combustion phase) the yoke rod (CR) (and hence the piston plates) moves towards front direction. Rear piston plate (PLT2) housed in ignition chamber (IC) while moving in the front direction sucks air-fuel mixture from primary fuel inlet valve (PVLV) into ignition chamber (IC) and front piston plate housed auxiliary compression chamber (ACC) compresses the air-fuel mixture and simultaneously get transferred into ignition chamber through hole in the yoke rod (CR). In the next semicircle rotation of Flywheel gear (FWG), air-fuel mixture in ignition chamber (IC) is compressed and at the end of this rotation combustion phase begins.

Scotch-Yoke Operation (First Model)

As, shown in FIG. 7, FIG. 21, and FIG. 22, in each quad-lateral crank-pin set left crank gear and right crank gear rotates in clockwise direction and anti-clockwise direction, respectively, with respect to axis pointing towards left direction. Upper crank gear and bottom crank gear rotates in clockwise direction and anti-clockwise direction, respectively, with respect to axis pointing upward direction. During the time duration yoke rod (CR) moves from rear to front direction, represented by straight arrow, left yoke pin moves towards midpoint from lower most point in the left sub-slot, right yoke pin moves towards midpoint from upper most point in the right sub-slot, upper yoke pin moves towards midpoint from left most point in the upper sub-slot, bottom yoke pin moves towards midpoint from right most point in the bottom sub-slot. We can see that torsional twist action on yoke slot caused by left and right yoke pins is mitigated by upper and bottom yoke pins. Sideward thrust of left yoke pin is mitigated by opposite thrust caused by right yoke pin.

Scotch-Yoke Operation (Second Model)

As shown in FIG. 12, FIG. 23, and FIG. 24, in the second model, in which left and right crank gears can mate with upper and bottom crank gears. In each quad-lateral crank-pin set, left crank gear and right crank gear rotates in clockwise direction and anti-clockwise direction, respectively, with respect to axis pointing towards left direction and upper crank gear and bottom crank gear rotates in anti-clockwise direction and clockwise direction, respectively, with respect to axis pointing upward direction. During the time duration yoke rod (CR) moves from rear to front direction, represented by straight arrow, left yoke pin moves towards midpoint from lower most point in the left sub-slot, right yoke pin moves towards midpoint from upper most point in the right sub-slot, upper yoke pin moves towards midpoint from right most point in the upper sub-slot, bottom yoke pin moves towards midpoint from left most point in the bottom sub-slot. Sideward thrust of left yoke pin is mitigated by opposite thrust caused by right yoke pin.

Scotch-Yoke Operation (Third Model and Fourth Model)

Third model, as shown in FIG. 16 and FIG. 25 in conjunction with FIG. 21 and FIG. 22, and fourth model, as shown in FIG. 21 and FIG. 26 in conjunction with FIG. 23 and FIG. 24, are a variation of first model and second model, respectively, in which crank gears of two crank-pin set on each side Scotch-Yoke operation chamber mate. Mating crank gears of two crank-pin set rotates in opposite direction. Therefore, pins of mating crank gears are configured to be in the opposite phase. Thus the first left yoke pin and second right yoke pin are in same phase, first right yoke pin and second left yoke pin are in same phase, first upper yoke pin and second bottom yoke pin are in same phase and first bottom yoke pins and second upper yoke pin are in same phase. Movement of pins of coupled crank gears represented by circular arrow. Torsional twist action and sideward thrust of a crank gear is additionally mitigated by that of mating crank gear.

1. A one cylinder axial internal combustion engine, suitable for high torque applications and allowing two phase compression mechanism to obtain high compression ratio, consisting of an ignition chamber, fuel suction and compression system and flywheel gear.

2. Ignition chamber, claimed in [claim 1], is an horizontal annular cylinder, extending from rear to front, capped at its rear side and have a spark plug, primary fuel inlet valve and exhaust valve mounted on its rear cap with primary fuel inlet valve and exhaust valve being poppet valves and primary fuel inlet valve being connected to air-fuel mixture source.

3. Fuel suction and compression system, claimed in [claim 1], which is designed for two phase suction-compression followed by combustion of air-fuel mixture in the ignition chamber, consists of Scotch-Yoke operation chamber, auxiliary compression chamber, fuel delivery mechanism wherein
Scotch-Yoke operation chamber, a horizontal rectangular pipe with circular hole in rear and front side, is located between ignition chamber and auxiliary compression chamber;
auxiliary compression chamber being a being an horizontal enclosure with rectangular cross-section and longitudinally coaxial cylindrical cavity of inner radius greater than and length equal to that of ignition chamber, with a front end cap, is sealingly attached at its rear end to the front end of Scotch-Yoke operation chamber;
fuel delivery mechanism, consists of an auxiliary valve, Multi-Slot-Scotch-Yoke operation mechanism and a Multi-Slot-Scotch-Yoke actuator;
auxiliary valve, is a poppet valve operated by a solenoid coil and is housed in the cylindrical deck on rear end of left wall of auxiliary compression chamber inside the region bounded by front end annular spur gear of left Flywheel-Scotch transmission mechanism and is connected to a air-fuel mixture source.

4. Fuel delivery mechanism, claimed in [claim 3], which performs suction of air-fuel mixture into ignition chamber and auxiliary compression chamber, compression of the mixture in both chambers and transferring compressed mixture from auxiliary compression chamber to ignition chamber has four different models, namely first model, second model, third model and fourth model, with each model differing from the other in comprising different model of Multi-Slot-Scotch-Yoke actuator and corresponding Multi-Slot-Scotch-Yoke operation mechanism wherein each model differ from others in the way
crank pins corresponding to a yoke slot are oriented with respect to each other and accordingly crank gears for the slot mesh or not mesh with adjacent crank gears;
crank gear corresponding to a yoke slot transmit rotatory force to crank gear corresponding to adjacent yoke slot by directly meshing or via an idler gear;
scotch yoke operation mechanism is configured corresponding to the configuration of crank-pin gear set.

5. According to the first model claimed in [claim 4], Multi-Slot-Scotch-Yoke actuator, claimed in [claim 1], is a multi-purpose quad-laterally operated double action multi slot scotch-yoke mechanism and consists of multiple yoke slots, multiple quad-lateral crank-pin set, each corresponding to a yoke slot, a connecting rod, front yoke rod support, and rear yoke rod support, multiple intermediate yoke rod support, multiple Inter-Slot Reinforcement Mechanism, front piston plate, rear piston plate, fuel pressure valve and compressor pressure valve wherein
each yoke slot is a yoke slot located such that slot opens towards left crank wheel, right crank wheel, upper crank wheel, and bottom crank wheel;
yoke slots are consecutively arranged that is, rear bounding plate of one yoke slot, parallely faces the front bounding plate of following yoke slot;
each yoke slot has four sub-slots, two of which, namely left yoke slot and right yoke slot, are obtained by vertically partitioning a vertical slot along the mid part, and other two sub-slots, namely, upper yoke slot and bottom yoke slot, are obtained by adjoining horizontally oriented slots on the upper and lower sides of the said vertical slot;
each yoke slot is located such that slot opens towards left crank wheel, right crank wheel, upper crank wheel, and bottom crank wheel;
connecting rod, which functions as continuous yoke slot, is a horizontal rod, with a longitudinal coaxial cylindrical hole, passing through all the slots, and attached to them;
front piston plate and rear piston plate, circular disks with holes at their centers, are attached coaxially to the front and rear end, respectively, of connecting rod;
front piston plate of radius equal to inner radius of auxiliary compression chamber and is housed coaxially inside the latter;
rear piston plate of radius equal to inner radius of ignition chamber and is housed coaxially inside the latter;
fuel pressure valve and compressor pressure valve are pressure valves, opening rearward (towards the ignition chamber), mounted coaxially to the centers of front piston plate and rear piston plate respectively, so that fuel, in the auxiliary compression chamber, under pressure can enter through compressor pressure valve pass through cylindrical hole in the connecting rod and exit from the fuel pressure valve into the ignition chamber;
each quad-lateral crank-pin set, which quad-laterally operates a yoke slot, comprises left yoke crank gear, right yoke crank gear, upper yoke crank gear and first bottom yoke crank gear, left inner bearing, right inner bearing, upper inner bearing, bottom inner bearing, left yoke pin, right yoke pin, upper yoke pin and bottom yoke pin;
each crank gear of quad-lateral crank-pin set is a spur gear journalled on corresponding side (left, right, upper or bottom) of inner wall of Scotch-Yoke operation chamber facing a yoke slot with its center along the midpoint of corresponding yoke slot via an inner ball bearing (which are annular thrust ball bearings) and engaged with corresponding sub-slot of corresponding yoke slot via corresponding yoke pin;
each pin of a quad-lateral crank-pin set, are cylindrical pegs projecting outwards from the periphery of a crank gear to engage with corresponding yoke sub slots;
crank gears corresponding to a yoke slot are assembled such that the corresponding left yoke pin and right yoke pin are on the opposite sides on the midpoint of the corresponding yoke slot with equal distance from the said midpoint and corresponding upper yoke pin and bottom yoke pin are on the opposite sides on the midpoint of the corresponding yoke slot with equal distance from the said midpoint;
left crank gear and right crank gear do not mesh with upper and bottom crank gear;
each inter-slot transmission mechanism, consists of four spur gears, namely left inter-slot gear, right inter-slot gear, upper inter-slot gear and bottom inter-slot gear, journalled on the inner side of left, right, upper and bottom wall, respectively, of scotch-yoke operation chamber, between the corresponding consecutive crank gears and function as idler gear;
front yoke rod support and rear yoke rod support are vertical rods, located inside Scotch-Yoke operation chamber, on front side of traversal space of front yoke slot and rear side of traversal space of rear yoke slot, respectively;
each intermediate yoke rod support is a horizontally oriented H-shaped truss of appropriated thickness, located inside Scotch-Yoke operation chamber, empty space between the traversal space of consecutive yoke slots;
each Inter-Slot Reinforcement Mechanism consists of four straight horizontal rods each of which connects oppositely facing bounding plates consecutive yoke slots near one of the four corners of said plates and passes through holes in horizontal arms of intermediate yoke rod support;
all yoke rod supports, has a hole through which connecting rod (that is, continuous yoke) passes through.

6. According to the first model, claimed in [claim 4], Multi-Slot-Scotch-Yoke operation mechanism, claimed in [claim 1], consists of a Flywheel gear (with a counter weight), Flywheel-Scotch transmission mechanism, multiple quad-lateral crank operation mechanism and inter-cam transmission mechanism, wherein
Flywheel gear, that functions as output of the engine, is a circular annular crown gear with its tooth projecting rearward (that is, towards Scotch-Yoke operation chamber) with weight connected to a section (functioning as counter weight) and is coaxially mounted on the outward side (capped front side) of auxiliary compression chamber;
each quad-lateral crank operation mechanism operates a quad-lateral crank-pin set corresponding to a yoke slot and comprises left cam follower gear, right cam follower gear, upper cam follower gear and bottom cam follower gear, left cam axis, right cam axis, upper cam axis, bottom cam axis, four ball bearings, namely, left outer bearing, right outer bearing, upper outer bearing, bottom outer bearing;
left cam follower gear, right cam follower gear, upper cam follower gear and bottom cam follower gear, of each quad-lateral crank operation mechanism, are spur gears coaxial to crank gears corresponding to yoke slot, with radius equal to half the radius of Flywheel gear, coaxially journalled on outer side the left, right, upper and bottom wall, respectively, of Scotch-Yoke operation chamber via corresponding ball bearings, left outer bearing, right outer bearing, upper outer bearing and bottom outer bearing, respectively;
left cam axis, right cam axis, upper cam axis and bottom cam axis are straight rods attached at one end to the center of left cam follower gear, right cam follower gear, upper cam follower gear and bottom cam follower gear respectively and extends inside the Scotch-Yoke Operation Chamber from latter's left, right, upper and bottom wall, respectively, to connect to the center of corresponding crank gear;
Flywheel-Scotch transmission mechanism facilitates transmission of rotation from cam follower gears of first (from the front side of the engine) quad-lateral crank operation mechanism to flywheel gear and vice-versa and consists of four sub-mechanisms, namely, left Flywheel-Scotch transmission mechanism, right Flywheel-Scotch transmission mechanism, upper Flywheel-Scotch transmission mechanism, bottom Flywheel-Scotch transmission mechanism;
each of left Flywheel-Scotch transmission mechanism, right Flywheel-Scotch transmission mechanism, upper Flywheel-Scotch transmission mechanism and bottom Flywheel-Scotch transmission mechanism, consists of gear train two (or more according to length of Auxiliary Compression Chamber) mating spur gears, arranged from rear to front, with one on the front end, necessarily, being annular spur gear, journalled to the outer side of left, right, upper and bottom wall, respectively, of Auxiliary Compression Chamber and front spur gear meshingly engages (towards the front end of Auxiliary Compression Chamber) with flywheel gear, (functioning as its pinion gear) and meshingly engages (towards the rear end of Auxiliary Compression Chamber) with the left cam follower gear, right cam follower gear, upper cam follower gear and bottom cam follower gear, respectively, of first quad-lateral crank operation mechanism;
each of left Flywheel-Scotch transmission mechanism, right Flywheel-Scotch transmission mechanism, upper Flywheel-Scotch transmission mechanism and bottom Flywheel-Scotch transmission mechanism, are gear trains of same number of gears and equal lengths;
each of inter-cam transmission mechanisms consists of four spur gears, namely left inter-cam gear, right inter-cam gear, upper inter-cam gear and bottom inter-cam gear, journalled on the outer side of left, right, upper and bottom wall, respectively, of scotch-yoke operation chamber, between the consecutive cam follower gears on corresponding side of scotch-yoke operation chamber and function as idler gear.

7. Second model, claimed in [claim 4], of Multi-Slot-Scotch-Yoke actuator and corresponding Multi-Slot-Scotch-Yoke operation mechanism, is a variation of the first model with the variation being
left and right crank gears of each crank-pin set are meshingly engaged with upper and bottom crank gears;
Flywheel-Scotch transmission mechanism is modified to rotate the first left, right, upper and bottom cam follower gears in consonance with two modification being
a) upper Flywheel-Scotch transmission mechanism, and bottom Flywheel-Scotch transmission mechanism, are gear trains of same number of gears but one gear more than that of left Flywheel-Scotch transmission mechanism, (or right Ignition-to-Scotch transmission mechanism);
b) radii of spur gears of upper Flywheel-Scotch transmission mechanism, bottom Flywheel-Scotch transmission mechanism are appropriately smaller than that of left Ignition-to-Scotch transmission gear, and right Flywheel-Scotch transmission mechanism, such that all the gear trains of Flywheel-Scotch transmission mechanism are of equal lengths.

8. Third model and fourth model, claimed in [claim 4], of Multi-Slot-Scotch-Yoke actuator, and corresponding Multi-Slot-Scotch-Yoke operation mechanism, are variations of first and second model, respectively, with the variation being
inter-slot transmission mechanism is removed (that is, interslot gears are removed) and consecutive crank gears on each side are meshingly engaged and pins of consecutive crank gears are oppositely oriented with respect to each other;
inter-cam transmission mechanism, is removed and consecutive cam follower gears on each side are meshingly engaged with each other.

9. In second and fourth model, upper and bottom crank gears may be crown gear with teeth extending in the vertical direction according to the depth of upper and bottom yoke sub-slots and crank gear teeth appropriately extend sideways to meshingly engage with neighboring gears.
